(19) United States
(12) Patent Application Publication
(10) Pub. No.: US 2010/0102542 A1
(43) Pub. Date: Apr. 29, 2010

(54) AIRBAG DEVICE

(75) Inventors: Yutaka Nakajima, Yokohama (JP); Ken Tanmachi, Yokohama (JP); Yosuke Shimizu, Yokohama (JP); Eri Kobori, Yokohama (JP)

Correspondence Address: HARNESS, DICKEY & PIERCE, P.L.C., P.O. BOX 828, BLOOMFIELD HILLS, MI, 48303, US

(73) Assignee: AUTOLIV DEVELOPEMENT AB, Vargarda (SE)

(21) Appl. No.: 12/522,063

(22) PCT Filed: Nov. 28, 2007
(86) PCT No.: PCT/JP2007/072934

§ 371 Date: Jul. 2, 2009

(30) Foreign Application Priority Data
Jan. 12, 2007 (JP) 2007-004553

(51) Int. Cl. B60R 21/16

(52) U.S. Cl. 280/743.2

(57) ABSTRACT

[PROBLEMS] To cushion impact acting on an occupant who is not in a regular position. [MEANS FOR SOLVING PROBLEMS] When an abnormality occurs, an airbag device (1) inflates and expands in front of an occupant and absorbs an impact from the front of a vehicle. An airbag (2) to which gas from an inflator is supplied in an abnormality is provided with a vertical recess (2c) facing the head (Ph) of the occupant (P). The recess (2c) is located at the center, in the right and left direction of the vehicle, of an occupant restriction surface (2b) formed at a position facing the occupant (P) sitting on the seat during inflation and expansion. At least one fixed vent (2ea, 2eb) and at least one variable vent (2fan, 2fb) are provided at each of opposite sidewalls (2da, 2db). The fixed vent (2ea, 2eb) has an invariant opening area, and the variable vents (2fan 2fb) has an opening area variable depending on the sitting position of the occupant (P) during expansion. The recess (2c) and the opposite sidewalls (2da, 2db) are coupled in the airbag (2) by shape control members (3a,3b). [EFFECT] Even an occupant of out of position or an occupant not wearing a seat belt can be received relatively flexibly, and trouble caused on the occupant by the airbag is reduced.

### TECHNICAL FIELD

The present invention relates to an airbag device which is able to control a load applied by an airbag to an occupant when it inflates and expands, even when the occupant is not sitting in a “regular position.”

Herein, an occupant sitting in a “regular position” refers to a state in which the upper part of the body of an occupant sitting in the front occupant's seat of a vehicle is positioned in the vicinity of the back rest portion of the front occupant's seat and an airbag device is disposed in the vehicle in the front occupant side.

### BACKGROUND ART

An airbag device for the front occupant's seat is installed, for example, inside the dashboard in front of the front occupant's seat in a position facing the front window. If the vehicle experiences an impact such as a collision, an inflator, which is assembled in a fixed position in a housing of the airbag, deploys, thereby supplying highly pressurized gas to the airbag so that the airbag inflates and expands toward the occupant to protect the occupant.

When this airbag inflates and expands, its occupant restraint surface makes contact with an occupant sitting in a regular position so that in the event of a collision, the occupant sitting in a regular position is protected from the impact of the dashboard or the front window by the inflated and expanded airbag.

Cushioning of the impact is achieved by the airbag when the occupant penetrates into the occupant restraint surface of the airbag. When this happens, as the occupant penetrates into the occupant restraint surface, a shift develops between the relative positions of the occupant and the occupant restraint surface, making it no longer possible for the airbag to uniformly absorb the impact, which results in an unbalanced load being applied to the occupant.

Accordingly, a device was disclosed in Patent Reference 1 wherein there is a fixed site for receiving and holding the occupant, to uniformly distribute the impact operating on the occupant. The airbag disclosed in Patent Reference 1 has separate chambers on the right and left sides for receiving and holding the left side of the chest and the right side of the chest, respectively, and is designed so that the vicinity of the sternum of the occupant faces the space between the chambers.

Patent Reference 1: Japanese Patent Application Kokai Publication No. 2004-244006

### DISCLOSURE OF THE INVENTION

### Problems to be Solved by the Invention

In one example, if a child is sitting in a child seat installed on the front occupant's seat, the sitting position is closer to the dashboard than a regular position. In the event that a child stands up, instead of remaining seated in the front occupant's seat, the child (occupant) is referred to as being “out of position.”

An occupant being out of position differs from an occupant sitting in a regular position and there are cases in which an out of position occupant is injured due to inflation and expansion of the airbag. However, no consideration was given to this problem in conventional airbags, including the airbag disclosed in Patent Reference 1.

Furthermore, since the airbag disclosed in Patent Reference 1 is separated into right and left chambers, when it deploys, one or the other chamber can be slower to inflate and expand, or there can be an imbalance in the internal pressure between the two chambers. In such cases, it is no longer possible to uniformly distribute the impact operating on the occupant.

In Patent Reference 1, the base end sides of the two chambers are designed to communicate with each other, but such construction techniques have inherent problems that cannot be eliminated. Therefore, if, for some reason, communication between the base ends of the two chambers is obstructed, the result could be fatal.

Moreover, in Patent Reference 1, since there is a space between the separate right and left chambers, a problem exists in that the chest cannot be retrained if the occupant is not wearing a seatbelt. For example, it is conceivable, that the vicinity of the space between the two chambers be connected by another piece of material. In this case, because the material is not a chamber it is impossible to apply internal pressure to this site. Thus, the inability to softly receive and hold the chest of the occupant remains.

Thus, an object of the present invention is to solve the problems of conventional airbag devices, which fail to consider occupants that are out of position or that are not wearing seatbelts.

### Means for Solving these Problems

The airbag device of the present invention is an airbag device which inflates and expands in front of an occupant when an abnormality occurs, thereby absorbing an impact from the front of the vehicle. The airbag device comprises: an inflator which injects gas when an abnormality occurs, and an airbag which inflates and expands when the gas is supplied from the inflator. The airbag is provided with a vertical recessed member facing the head of the occupant that is located at the center portion, as measured in the right and left direction of the vehicle, of an occupant restraint surface formed at a position facing the occupant sitting in a seat during the inflation and expansion of the airbag. The airbag also includes at least one fixed vent having an opening that has a substantially constant area and at least one variable vent provided at each of the two sidewalls, the variable vent having an opening area that changes according to the sitting position of the occupant during deployment. The recessed member and the two sidewalls are coupled inside the airbag by a shape control member.

Since the airbag device of the present invention is provided with a vertical recessed member that faces the head of the occupant at the center portion of the occupant restraint surface, as measured in the right and left direction of the vehicle, the occupant's head can be reliably received and held by this recessed member and an unbalanced load will not be applied to the occupant when the impact is being absorbed.

When this occurs, the occupant's head penetrates the recessed member, and though the airbag changes shape toward the front of the vehicle, it inflates so that the two sidewalls deploy in the right and left direction of the vehicle and a shape control member wraps around the outer circumference of the head to protect it in conjunction therewith, such that the recessed member is able to maintain a constant shape.

Furthermore, even if the occupant is out of position or is not wearing a seatbelt, it is possible to control the deployment of the airbag in a suitable manner due to the presence of the at least one fixed vent and one variable vent in the two sidewalls.

In other words, if the occupant is out of position or is not wearing a seatbelt, the occupant starts to penetrate into the airbag sooner than an occupant in a regular position and before the airbag completely inflates and expands.

Therefore, if, for example, a cylindrical member is attached to the variable vent, and the occupant restraint surface side and the variable vent are connected with a tether, for example, a cord, provided within the airbag, the tether is pulled in the process of airbag inflation and expansion, and the variable vent is tightened from a completely open state to a completely closed state. In this case, the cylindrical member is provided with a tube which protrudes from both sidewalls at the base end side to the either outer side or the inner side of the airbag, thereby attaching the base end side to the variable vent. The tether may be attached to freely slide at the tip portion of the tube.

Accordingly, if the occupant penetrates into the airbag before it completely inflates and expands, the variable vent does not become completely closed, thereby making it possible to accept and hold the occupant in a relatively soft manner that reduces the risk of injury from the airbag to the occupant.

Furthermore, even in cases where the position of an occupant who is out of position shifts in the right and left direction of the vehicle, the amount of penetration to the airbag on the side where the occupant is positioned increases, and the amount of pulling of the tether decreases.

On the other hand, even if the variable vent disposed on the side where the occupant is not positioned tries to close, it is pulled and shifted by the deployment behavior on the side where the occupant is positioned, so the airbag no longer completely deploys, thereby reducing potential injury to the occupant caused by the airbag.

In the present invention, the terms “vertical,” or “upwards” and “downwards,” describe a part or direction positioned toward the roof side or floor side of the vehicle relative to a certain part. The term “upwards” and its derivatives describes a part of direction positioned toward the roof side of the vehicle relative to a certain part, while the term “downwards” and its derivatives describes a part or direction positioned toward the floor of the vehicle relative to a certain part. Furthermore, “center portion” refers to an area in the vicinity of a central portion which expands upwards and downwards or towards the right and left, including a geometric center therebetween, and “intermediate portion” represents an entire area excluding the end portions upwards and downwards or toward the right and left.

### Advantageous Effects of the Invention

Since the present invention is able to reliably accept and hold an occupant's head by means of a recessed member which maintains a constant shape, an unbalanced load does not operate on the occupant when an impact is absorbed. Moreover, even an occupant out of position or not wearing a seatbelt can be received and held in a relativelysoft manner, thereby reducing potential injury to the occupant caused by the airbag.

### BRIEF DESCRIPTION OF THE ATTACHED DRAWINGS

FIG. 1 is a perspective view of a state wherein the airbag of the airbag device of the present invention in a front occupant's seat inflates and expands, as seen from an elevated diagonal position on the side of the occupant restraint surface.

FIG. 2 is a view of FIG. 1 as seen from the occupant restraint surface.

FIG. 3 is an elevated view of the internal structure of the state shown in FIG. 1 and FIG. 2.

FIG. 4 (a) is a side view of the internal structure of the state shown in FIG. 1 to FIG. 3 as seen from the occupant's seat side. FIG. 4 (b) is an enlarged view of portion X in FIG. 4 (a).

FIG. 5 is a side view like FIG. 4, showing a simulation of airbag inflation and expansion when the occupant is out of position.

FIG. 6 is a drawing illustrating another example of FIG. 4 (b).

FIG. 7 is a drawing illustrating an example when a variable vent is disposed more on the side of the occupant restraint surface than the position shown in FIG. 4.

FIG. 8 is a drawing showing a side view of an airbag in a state in which the occupant is not wearing a seatbelt is taken into consideration.

FIG. 9 is a graph showing the results of a sled test in which the airbag of FIG. 4 is provided without a variable vent and is installed in a compact car, and the occupant is sitting in a regular position.

FIG. 10 is a graph showing the results of a sled test in which the airbag of FIG. 5 is provided without a recessed member and is installed in a compact car, and the occupant is sitting out of position (standing in a position near the dashboard).

FIG. 11 is a drawing similar to FIG. 1 illustrating another means for varying the opening area of a variable vent.

FIG. 12 is an elevated view of the internal structure of the state shown in FIG. 11.

### DESCRIPTION OF THE REFERENCE SYMBOLS

A Dashboard
B Windshield
P Occupant
1 Airbag device
2 Airbag
2b Occupant restraint surface
2c Recessed member
2da, 2db Sidewalls
2ea, 2eb Fixed vents
2fa, 2fb Variable vents
2h Chest restraint surface
3a, 3b Shape control member
4 Opening area variation means
4a Cylindrical member
4aa Tube
4d Tether
4e Release opening

### PREFERRED EMBODIMENT

As discussed above, conventional airbags do not give consideration to out of position occupants or occupants not wearing seat belts.

In contrast, the embodiments of the airbag of the present invention give consideration to an occupant that is out of position or not wearing a seat belt, and makes it possible to deploy the airbag in a suitable manner, due to at least one fixed vent and one variable vent provided in the airbag's two sidewalls.

### EXAMPLE

An airbag device according to the present invention is described in detail below using an example and the appended drawings illustrate a preferred embodiment thereof.

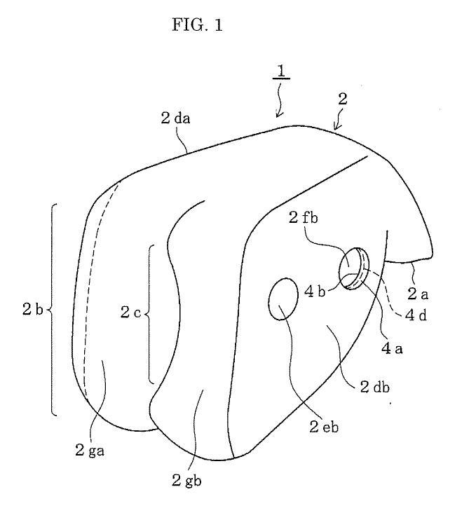

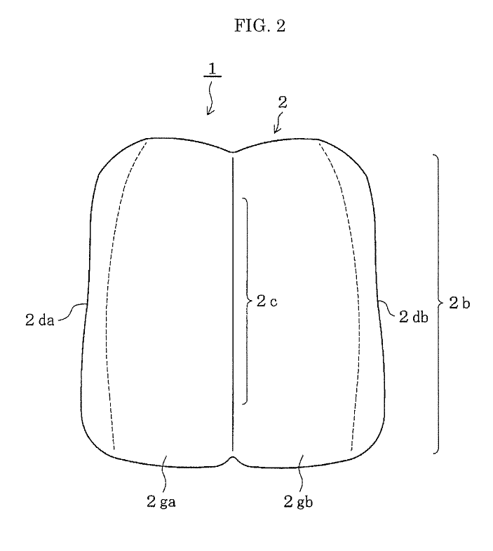

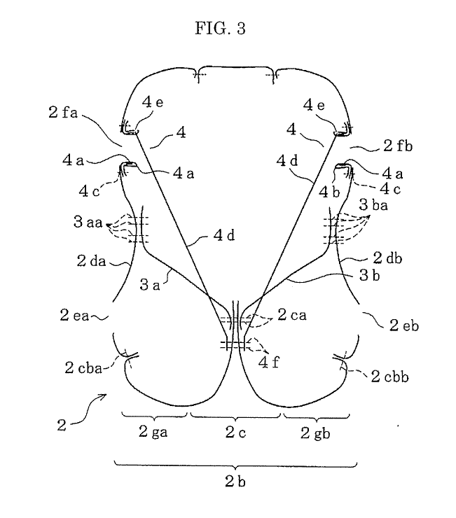

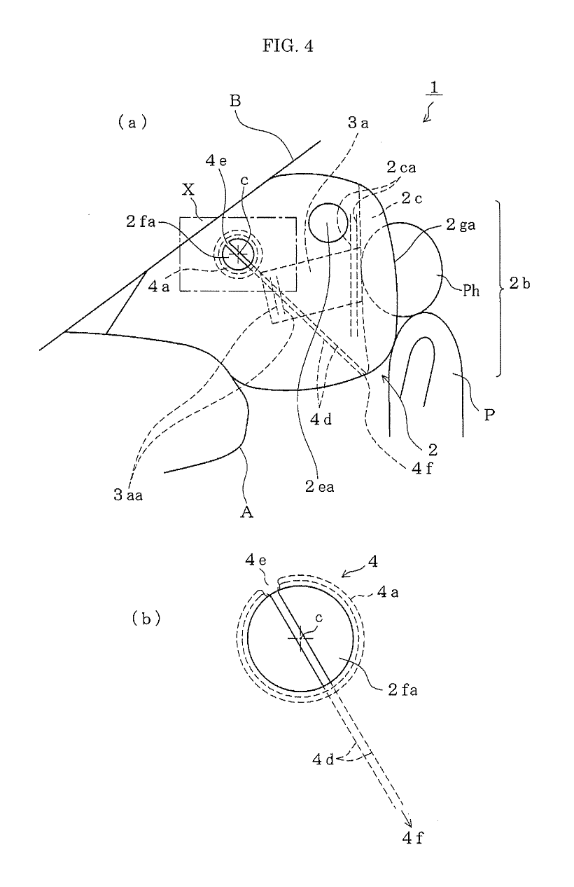

FIG. 1 is a perspective view of a state wherein an airbag of an airbag device of the present invention disposed in a front occupant's seat inflates and expands, as seen from an elevated diagonal position on the side of the occupant restraint surface. FIG. 2 is a view of FIG. 1 as seen from the occupant restraint surface. FIG. 3 is an elevated view of the internal structure of the state shown in FIG. 1 and FIG. 2. FIG. 4 is a side view of the internal structure of the state shown in FIGS. 1 to 3 as seen from the occupant's seat side.

The airbag device 1 for the front occupant's seat is installed inside the dashboard A in front of the front occupant's seat in a position facing the front window B. Typically, the airbag device includes an inflator assembled in a fixed position in a housing, and an airbag 2 which inflates and expands by means of a highly pressurized gas released by the inflator.

When a vehicle is impact as a result of a crash, the inflator is initiated and generates a highly pressurized gas. This highly pressurized gas is supplied via a high-pressure gas inflow orifice 2a to the inside the airbag 2. When this highly pressurized gas is supplied, the airbag 2 inflates and expands toward an occupant sitting in the front occupant's seat, thereby preventing the occupant from colliding with the dashboard A or the windshield B.

The airbag device 1 may be provided with a recessed member 2c in an upwards and downwards direction facing the head Ph of an occupant P, and in the center portion of an occupant restraint surface 2b, as measured in the right and left direction of the vehicle. The recessed member 2c is disposed in a position facing the occupant P seated in the front occupant's seat when the airbag 2, which is formed, for example, by 1 chamber, inflates and expands.

This recessed member 2c is formed, for example, by providing a sewn portion 2ca in a fixed range upwards and downwards in the center of the occupant restraint member 2b in the right and left direction of the vehicle, and by providing sewn portions 2cba and 2cbb upwards, downwards, and also across both edges of the occupant restraint member 2b in the right and left direction of the vehicle.

Because the recessed member 2c is formed in the occupant restraint member 2b, it is possible to control the position at which the load of the occupant P is received and held in cases where the occupant restraint member 2b makes contact with the occupant P sitting in a regular position in the front occupant's seat when the airbag 2 inflates and expands.

Moreover, substantially circular fixed vents 2ea and 2eb and variable vents 2fa and 2fb may be provided, for example, in sidewalls 2da and 2db of the airbag 2 of the side of the occupant restraint member 2b. One substantially circular fixed vent 2ea or 2eb may be disposed, for example, approximately symmetrically in the right and left side.

Since the opening area of the fixed vents 2ea and 2eb does not change, regardless of the sitting position of the occupant P, the fixed vents 2ea and 2eb operate to control the internal pressure of the airbag 2. On the other hand, the surface area of the opening of the variable vents 2fa and 2fb changes depending on the sitting position of the occupant P when the airbag 2 inflates and expands. Due to these changes in the surface area of the opening of the variable vents 2fa and 2fb, it is possible to receive and hold the occupant P in a relatively soft manner, even when the occupant is out of position, thereby reducing potential injury to the occupant P caused by the airbag 2.

In this embodiment, an example of a surface area opening variation means 4 is may be a achieved through a cylinder member 4a that is open on both sides. The cylinder member may be controlled by variably tightening a tether 4d having a cross-section which is circular or in the shape of a thin band. In the example of FIG. 4, the cylindrical member 4a is folded back at the center portion, and its end is sewn to the variable vents 2fa and 2fb.

In this case, the dimensions from the folded back part 4b to the sewn part 4c are determined so as to obtain a surface area that is equal to or greater than the surface areas of the openings of variable vents 2fa and 2fb, respectively. In addition, one end of the tether 4d is sewn to the center portion near the lowest end of the occupant restraint surface 2b (sewn portion 40, and the other end is inserted through a release opening 4e provided in the vicinity of the folded back part 4b at a position that passes through the approximate center c of the variable vents 2fa and 2fb. The tip of the inserted tether 4d is wound once within the cylindrical member 4a, which was folded back at the center portion, and then removed through the release opening 4e, after which it is sewn at the same position as the end portion.

The length of the other end side of the tether 2d, which was removed from the release opening 4e, is equivalent to the length when the two variable vents 2fa and 2fb are completely closed and the cylindrical member 4a, which is attached to the two sidewalls 2da and 2db, is tightened by immobilizing one end of the tether 4d when the airbag 2 has completely inflated and expanded.

Because the surface area opening variation means 4 has this structure, if a child riding in the front occupant's seat is near the dashboard in a forward facing standing position when the airbag 2 deploys, the amount of opening and closing of the variable vents 2fa and 2fb is controlled as follows.

Before the airbag 2 inflates and expands in the normal configuration shown in FIGS. 1-4, the airbag comes in contact with the child standing up in a position near the dashboard A, so the amount of pulling on the tether 4d decreases. Therefore, the variable vents 2fa and 2fb are maintained in an open state without completely closing, and the highly pressurized gas is released from the variable vents 2fa and 2fb. As a result, the airbag 2 is no longer able to inflate and expand for more than the contact time, and the child is softly received and held.

In experiments performed by the inventors, optimal results were obtained when the inner diameter of the variable vents 2fa and 2fb was between about 50 to about 150 mm and the inner diameter of the fixed vents 2ea and 2eb was about 30 to about 100 mm.

Furthermore, in the present invention, the recessed member 2c and the sidewalls 2da and 2db are coupled within the airbag 2 by shape control members 3a and 3b, which are formed from a tether of the same base fabric as the airbag 2, for example.

As shown in FIG. 2 to FIG. 4, the shape control members 3a and 3b are attached at one end to approximately the center portion of the sewn portion 2ca in an upwards and downwards direction at a constant width of about 100 to about 500 mm, with overlapping reinforcement stitches included on both sides. The other end is attached to the intermediate portion of the sidewalls 2da and 2db by sewing in an upwards and downwards direction, and preferably to the center portion of the sidewalls 2da and 2db in an upwards and downwards direction with respect to the occupant restraint surface 2b, including overlapping reinforcement stitches. Reference symbols 3aa and 3ba represent the sewn portion of the other end of the shape control members 3a and 3b.

When such shape control members 3a and 3b are attached, the shape of the recessed member 2c is determined by the sewing lengths of the shape control members 3a and 3b, respectively. The two sides of the occupant restraint surface 2b in the right and left directions of the vehicle form protruding portions 2ga and 2gb with respect to the recessed member 2c.

Furthermore, when the occupant P penetrates into the airbag 2 (the occupant restraint surface 2b) after complete deployment, the sidewalls 2da and 2db expand so as to project in the right and left direction of the vehicle, and the sewn portions 3aa and 3ba are respectively confined to the outer side, so that the recessed member 2c continues to retain a constant shape. That is to say, the load on the occupant P is distributed uniformly since the head Ph of the occupant P can be received and held by the recessed member 2c, and the shoulders can be received and held by the protruding portions 2ga and 2gb, enabling them to be received and held more softly.

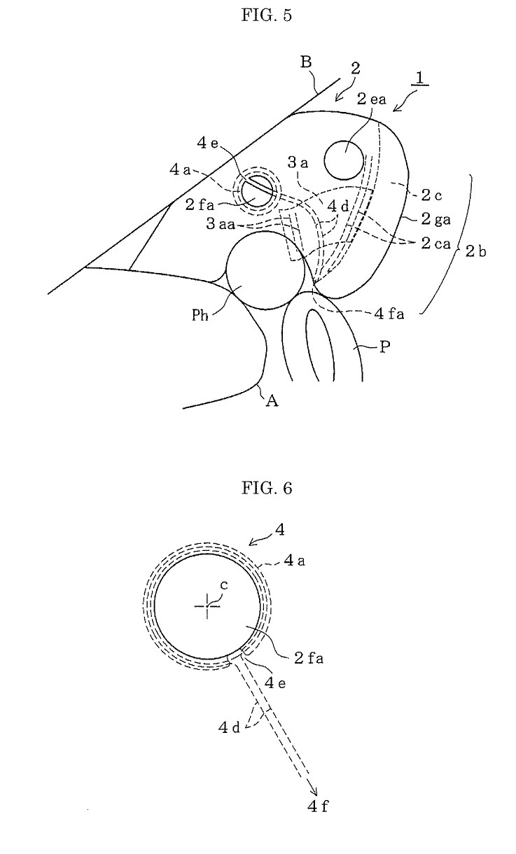

In contrast to FIG. 4, which illustrates the case where the occupant P is sitting in a regular position, FIG. 5 is a side view simulating the state when the airbag 2 has inflated and expanded when the occupant P (a child) is out of position.

When the occupant is out of position, the vicinity of the lowest end of the occupant restraint surface 2b of the airbag 2 is in an uninflated and unexpanded state. In this state, the tether 4d cannot completely close the variable vents 2fa and 2fb since the stroke up to the inflation and expansion position shown in FIG. 4 is not produced in the sewn portion 4f, thus the variable vents 2fa and 2fb support an open position. Therefore, the highly pressurized gas is released not only from the fixed vents 2ea and 2eb, but also from the variable vents 2fa and 2fb, and the airbag 2 does not inflate and expand up to the state shown in FIG. 4.

FIG. 6 is a drawing illustrating another example of the opening area variation means 4 of the variable vents 2fa and 2fb shown in FIG. 4.

In the example illustrated in FIG. 6, the release opening 4e is provided in the vicinity of the folded back part 4b on the side of the sewn portion 4f in a line connecting approximately the center c of the variable vents 2fa and 2fb and one end of the sewn portion 4f of the tether 4d. The tether 4d, which is inserted from this release opening 4e is circulated twice within the cylindrical member 4a that is folded back at the center portion and is removed from the release opening 4e. Thereafter, the tether 4d is sewn in the same position as the one end mentioned above.

In this case, the stroke required to completely close the variable vents 2fa and 2fb is double that of the example shown in FIG. 4. Likewise, the stroke applied when the tether 4d is removed from the release opening 4a and circulated 3 times within the cylindrical member 4a, is 3 times that of the example shown in FIG. 4, and therefore the stroke is similar to that of the comparative example. In other words, it is preferable to employ different strokes according to different shapes of the airbag 2.

However, when the tether 4d is circulated one time within the cylindrical member 4a, it becomes possible to more reliably control the opening and closing of the variable vents 2fa and 2fb when the tether 4d is removed from the release opening 4e, which is provided in the vicinity of the folded back part 4b at a position passing through approximately the center c of the variable vents 2fa and 2fb.

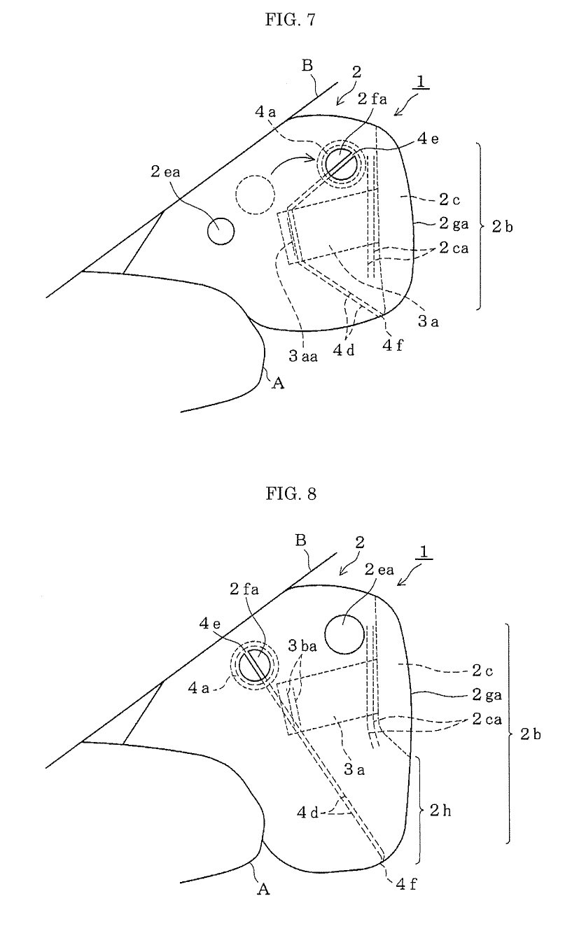

In FIG. 7, a portion of the shape in the sewn portions 3aa and 3ba at the other end of the shape control members 3a and 3b described in FIG. 4 is sewn in a cylindrical shape through which the tether 4d can freely slide through from the top side of the shape control members 3a and 3b to the bottom side thereof.

According to such a structure, since these sewn portions 3aa and 3ba form a guide hole for the tether 4d, the disposition of the variable vents 2fa and 2fb can be on the side of the occupant restraint surface 2b, as shown in FIG. 7, rather than as in the example shown in FIG. 4. Furthermore, although it is not shown, they can also be disposed on the side of the occupant restraint surface 2b opposite that of the example shown in FIG. 4. In other words, an optimal design is possible even in an airbag configuration differing from this example.

FIG. 8 shows a side view of the airbag 2, taking into consideration the case where the occupant is not wearing a seatbelt.

The airbag 2, which takes into consideration a state in which the occupant is not wearing a seatbelt, typically requires that the airbag 2 also be provided with a restraint surface for the chest, so the height of the occupant restraint surface 2b is greater in the downwards direction than in the airbag 2 shown in FIG. 4.

In this case, when there is a space for releasing the restraint surface for the chest toward the occupant P, such as the recessed member 2c, it is not possible to retrain the chest, so the chest restraint surface must be formed in a convex shape. In other words, the width of the shape of the control members 3a and 3b is modified from about 100 to about 500 mm to about 100 to about 250 mm and the recessed member 2c is provided only to the portion that faces the vicinity of the head Ph of the occupant P. In so doing, a convex chest restraint surface 2h is formed at the lower side of the recessed member 2c, due to the fact that the shape control members 3a and 3b are not provided.

In other words, in the example shown in FIG. 8, the occupant's head Ph is restrained by the recessed portion 2c, the shoulders are restrained by the convex portions 2ga and 2gb, and the chest is restrained by the convex chest restraint surface 2h.

Accordingly, in the present invention, a variety of different types of airbags can be provided, by adjusting the shape of the base fabric of the airbag 2, the width of the shape control members 3a and 3b, and the position of the sewn portions 2ca, 2cb and 3aa, 3ba.

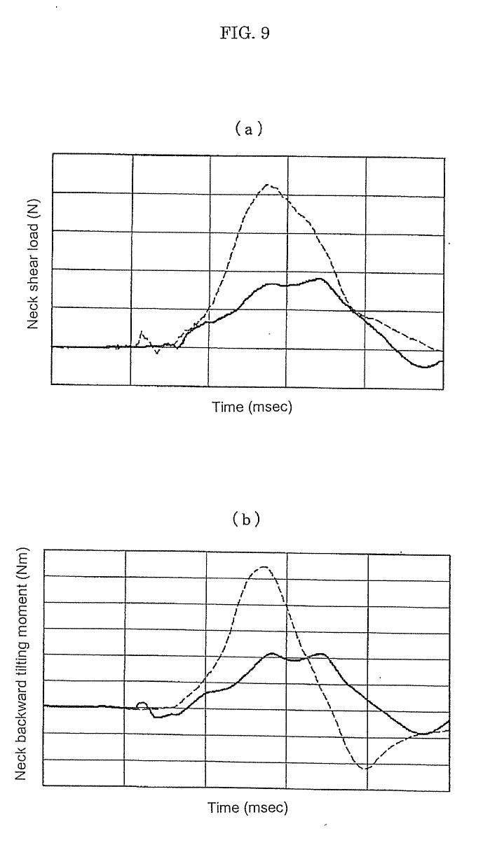

FIG. 9 is a graph showing the results of a sled test (simulated vehicle collision test) in which an airbag device without the variable vent 2fa and 2fb provided in the airbag 2 of FIG. 4 is installed in a compact car and an occupant is sitting in a regular position. FIG. 9 (a) shows the test results for neck shear load, and FIG. 9 (b) shows the test results for neck backward tilting moment.

When a comparison is made between the prior art airbag (dashed line) without the recessed member 2c, and an airbag provided with the recessed member 2c without the variable vents 2fa and 2fb, there is found to be a decrease of 56% in the peak value for neck shear load and a decrease of 65% in the peak value for neck backward tilting moment.

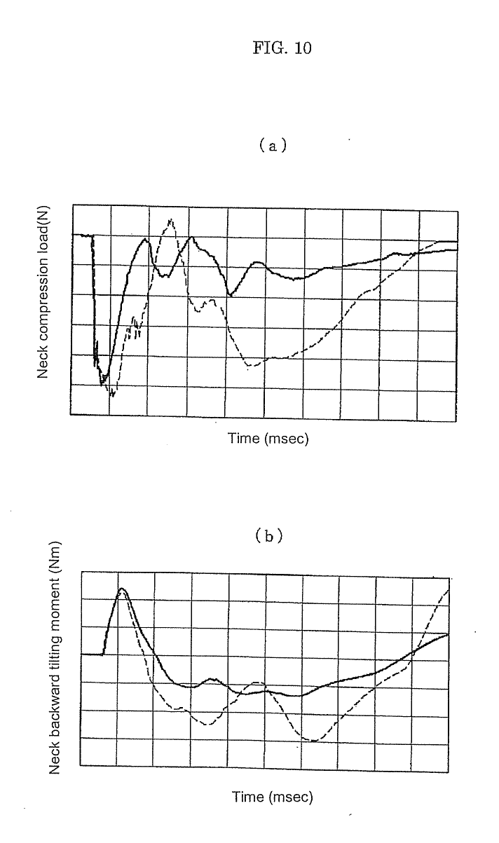

FIG. 10 is a graph showing the results of a sled test in which an airbag device without the recessed member 2c provided to the airbag 2 of FIG. 5 is installed in a compact car, and an occupant is sitting out of position (standing in a position near the dashboard). FIG. 10 (a) shows the test results for neck compression load, and FIG. 10 (b) shows the test results for neck backward tilting moment.

When a comparison is made between the prior art airbag (dashed line) without the recessed member 2c, and an airbag provided with the variable vents 2fa and 2fb without the recessed member 2c, there is found to be a decrease of 57% in the peak value for neck compression load and a decrease of 53% in the peak value for neck backward tilting moment.

Based on these test results, it can be deduced that the present invention airbag device 1 provided with the recessed member 2c and the variable vents 2fa and 2fb is capable of greater control over the impact on the occupant P.

The present invention is not limited to the above example, and the embodiments can of course be suitably modified, as long as they are within the scope of the technical ideas recited in the claims.

For example, in the above example, the shape control members 3a and 3b have a constant width, but at the shorter side of the sewn portions 3aa and 3ba the shape control members 3a and 3b may be fan-shaped and have a width of about 100 to about 500 mm.

The shape control members 3a and 3b may employ a material that is separate from the airbag 2, and may utilize a single sheet or multiple layered sheets, the shape control members 3a and 3b may also be formed in portions over the above-mentioned range by using tethers or the like. In other words, the sewn portion 2ca and the sewn portions 3aa, 3ba may be joined at an optimal position and range.

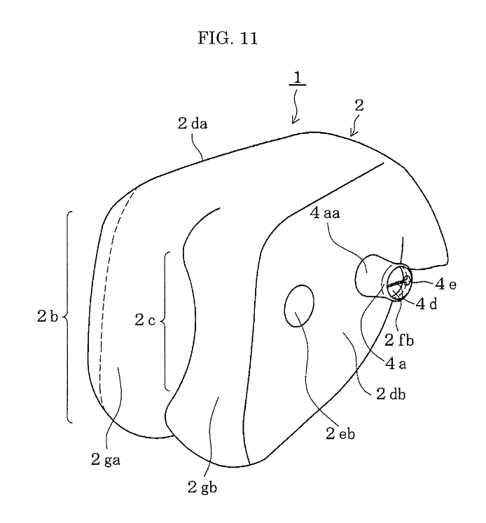

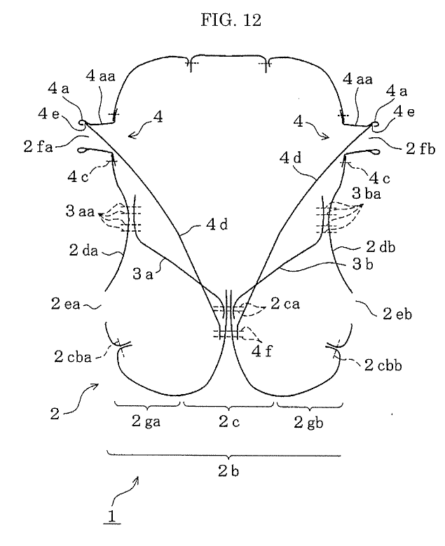

The cylindrical member 4a of the opening area variation means 4 is of course not limited to the example given in FIG. 3. As shown in FIG. 11 and FIG. 12, for example, a tube 4aa may be provided at the base end side of the cylindrical member 4a, and the cylindrical member 4a may be caused to protrude from the sidewalls 2da and 2db toward the outside of the airbag 2. Conversely, the cylindrical member 4a may be caused to protrude from the sidewalls 2da and 2db toward the inside of the airbag 2.

Moreover, in the above example, the airbag 2 was formed from 1 chamber, but a plurality of chambers may be formed, as in Patent Reference 1.

### INDUSTRIAL APPLICABILITY

In the above example, the airbag device employing the structure of the present invention is described as being installed in the front occupant's seat of an automobile, but it may also be installed in a seat other than the front occupant's seat, or in an occupant vehicle other than an automobile, such as an airplane or a ship.

1. An airbag device comprising:
an inflator which injects gas upon an occurrence of a predetermined event;
an airbag which inflates and expands when the gas is supplied from the inflator, the airbag being provided with a vertical recessed member facing a head of an occupant, the vertical recessed member being disposed at a center portion of an occupant restraint surface measured in a right to left direction of a vehicle, the occupant restraint surface being formed at a position facing the occupant sitting in a seat during the inflation and expansion of the airbag, and
at least one fixed vent having an opening which has a substantially constant area and at least one variable vent having an opening area that changes according to the sitting position of the occupant during deployment, the at least one fixed vent and variable vent disposed in each of two sidewalls of the airbag,
wherein, the recessed member and the two sidewalls are coupled inside the airbag by a shape control member.

2. The airbag device according to claim 1, wherein the shape control member is a fabric coupling a vertical center portion of the recessed member and a vertical intermediate portion of the two sidewalls.

3. The airbag device according to claim 1, wherein the fixed vent and the variable vent of the two sidewalls are disposed approximately symmetrically right and left, respectively.

4. The airbag device according to claim 1, further comprising a cylindrical member attached to the variable vent and a tether which connects anoccupant restraint surface and the variable vent inside the airbag.

5. The airbag device according to claim 3, further comprising a cylindrical member attached to the variable vent and a tether which connects an occupant restraint surface and the variable vent inside the airbag.

6. The airbag device according to claim 4, wherein the cylindrical member is provided with a tube that protrudes from the two sidewalls on a base end side to either an outside or an inside of the airbag, the base end side being attached to the variable vent, wherein the tether is attached so as to feely slide at a tip portion of the tube.

7. The airbag device according to claim 5, wherein the cylindrical member is provided with a tube that protrudes from the two sidewalls on a base end side to either an outside or an inside of the airbag, the base end side being attached to the variable vent, wherein the tether is attached so as to feely slide at a tip portion of the tube.

8. The airbag device according to claim 1, wherein a convex chest restraint surface is further formed below the recessed member.

9. The airbag device according to claim 3, wherein a convex chest restraint surface is further formed below the recessed member.

10. The airbag device according to claim 4, wherein a convex chest restraint surface is further formed below the recessed member.

11. The airbag device according to claim 1, wherein the airbag is formed with a single chamber.

12. The airbag device according to claim 3, wherein the airbag is formed with a single chamber.

13. The airbag device according to claim 4, wherein the airbag is formed with a single chamber.

14. The airbag device according to claim 8, wherein the airbag is formed with a single chamber.
